(19) United States
(12) Patent Application Publication
(10) Pub. No.: US 2013/0164578 A1
(43) Pub. Date: Jun. 27, 2013

(54) BATTERY MODULE

(71) Applicants: Edward Thomas Sweet, San Francisco, CA (US); Paul Young Durkee, San Francisco, CA (US); Nathaniel Hall-Snyder, Park City, UT (US)

(72) Inventors: Edward Thomas Sweet, San Francisco, CA (US); Paul Young Durkee, San Francisco, CA (US); Nathaniel Hall-Snyder, Park City, UT (US)

(21) Appl. No.: 13/334,014

(22) Filed: Dec. 21, 2011

(51) Int. Cl. H01M 10/50; H01M 2/12; F28F 9/007; H01M 10/02

(52) U.S. Cl. 429/82; 429/72; 165/67

(57) ABSTRACT

A modular battery module that includes a plurality of substantially identical cartridges, a chassis, and a compression member, wherein each cartridge includes a heat sink with a thermal management channel; a prismatic cell coupled to the heat sink; and a first and a second manifold fluidly coupled to the thermal management channel, wherein the first and second manifolds form opposing edges of a frame, wherein the frame supports the edges of the heat sink. The plurality of cartridges is coupled together in the thickness direction to form a stack with a first and a second end. The chassis is formed from a first end plate, a second end plate, and the plurality of frames, wherein the first and second end plates cap the ends of the stack. The compression member couples the end plates and cartridges together, wherein the compression member applies a compressive force over a face of the batteries.

### TECHNICAL FIELD

This invention relates generally to the battery pack field, and more specifically to a new and useful battery pack construction in the battery pack field.

### BACKGROUND

In the battery industry, there has been a trend toward smaller power sources with higher energy densities to accommodate the higher power requirements and smaller form factors of consumer products. This trend is clearly seen in power sources for electric vehicles, wherein high power and energy density is especially important in allowing the vehicle to carry enough portable power to match the power and driving range provided by conventional fuel powered vehicles within the constraints of the vehicle frame. Higher power and energy densities may be achieved by packing a larger number of battery cells into a volume and/or using cells that contain chemistries with higher power and energy densities. As seen in the field of portable battery packs, cells with a prismatic shape (such as lithium polymer cells) are being considered to increase packing efficiency and to achieve power sources with higher power and energy densities. These prismatic battery cells typically include an internal layer structure of anode, cathode, and polymer layers that are stacked to form the prismatic shape of the cell. Because of the internal layer structure of prismatic cells, prismatic cells may increase in thickness (as much as 10% increase in thickness) throughout the life of the cell. Because prismatic cells may be stacked within battery packs, this increase in thickness may cause misalignment and damaged electrical connections within the cell and/or within the battery pack. Additionally, the internal layers may separate through the life of the cell, leading to less optimal contact between layers and potentially decreasing the efficiency and life of the cell. Vibration intensive applications, such as driving, may accelerate the rate of layer separation. This is particularly apparent in battery modules with suspended battery systems, wherein the relative motion between two adjacent cells, resulting from a lack of static cell support, damages the internal cell layers apart. Furthermore, the higher loads required from the power sources may also increase the rate of cell degradation due to the high temperatures generated by the batteries during operation.

Thus, there is a need in the battery pack field to create a new and useful battery module that provides adequate thermal management, support and compression to the batteries while minimizing the battery module form factor. This invention provides such a new and useful battery module.

### BRIEF DESCRIPTION OF THE FIGURES

FIGS. 1A and 1B are exploded views of an embodiment of the battery module and an embodiment of the cartridge, respectively.

FIG. 2 is an exploded view of a second embodiment of the battery module.

FIGS. 3A, 3B, and 3C are a perspective view of an embodiment of the heat sink, a close-up view of the edge of an embodiment of the heat sink, and an exploded view of an embodiment of the heat sink, respectively.

FIG. 4 is a perspective view of an assembled cartridge.

FIGS. 5A and 5B are side views of a first and a second embodiment of the assembled cartridge.

FIG. 6 is a perspective view of the chassis.

FIGS. 7A and 7B are a perspective view and a close up view of a first embodiment of the pressure member, respectively.

FIGS. 8A and 8B are perspective views of a first and second face of a second embodiment of the pressure member, respectively.

FIGS. 9A and 9B are a perspective view and a cutaway view of a third embodiment of the pressure member, respectively.

FIG. 10 is a top view of a thermal management fluid flow path through the battery module.

FIG. 11 is an exploded view of a battery module assembly method.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

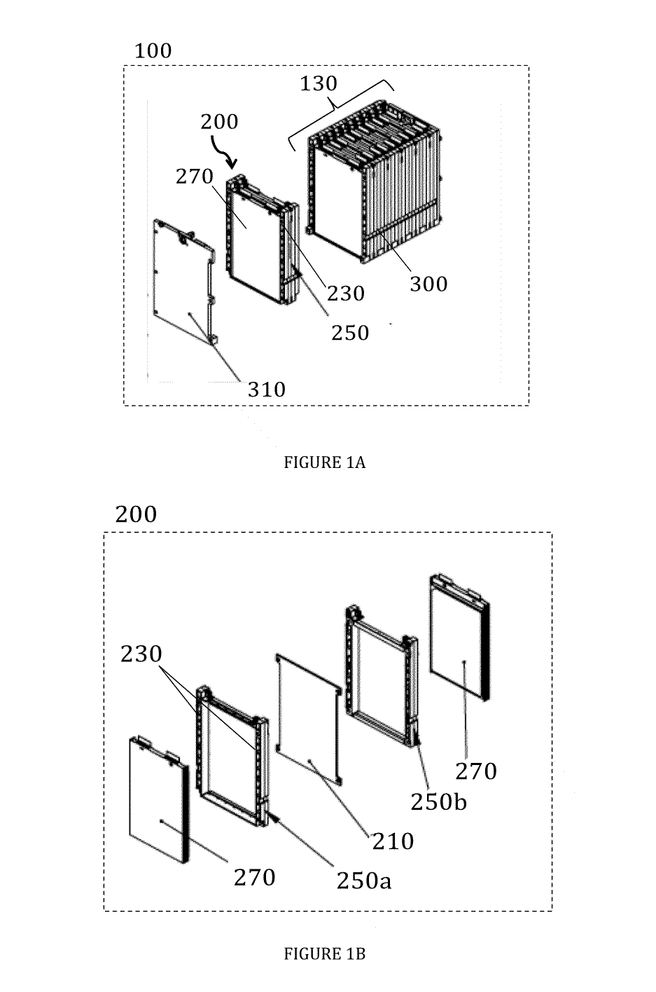

As shown in FIG. 1, the battery module 100 of the preferred embodiments includes a cartridge 200 and a chassis 300. The cartridge 200 includes a heat sink 210, a manifold 230 fluidly coupled to the heat sink 210, a frame 250 supporting the heat sink 210, and a battery cell 270 coupled to the heat sink 210 (shown in FIG. 1B). The chassis 300 is collectively formed from one or more coupled cartridge frames 250 and an end plate 310, wherein the end plate 310 is disposed on an uncoupled end of the cartridge 200 and applies a substantially compressive force over the face of the cell 270. The battery module 100 functions to support and cool the cells contained therein, and is preferably utilized to provide power to a vehicle, but may alternatively be used with portable consumer electronics, external skeletons, or any suitable application. The battery module 100 is preferably used with a thermal management fluid, wherein the thermal management fluid flows through the manifold 230 and heat sink 210 to cool the coupled cell 270. The thermal management fluid is preferably air (e.g. from ambient), but may alternatively be water, refrigerant, or any suitable thermal management fluid. The thermal management fluid is preferably provided to the battery module 100 by a pump, but may alternatively be provided to the battery module 100 by moving the battery module 100 through a reservoir of the thermal management fluid (e.g. a vehicle moving the battery module 100 through ambient air), or by any suitable thermal management fluid provision method. As shown in FIG. 1A, the battery module 100 is preferably formed from multiple cartridges 200, each associated with one or more battery cells, that are coupled together to form a cartridge stack 130, wherein the overall power of the battery module 100 is preferably the sum total of the power from each of the cartridges 200. By breaking the battery module into discretized cartridges (each containing a small number of cells), this battery module 100 affords several advantages over other battery module architectures. First, the battery module 100 may decrease the rate of cell layer separation and potentially increase the efficiency and life of the cells by reducing the amount of cell movement and by providing increased thermal management. Because each cell 270 is substantially statically coupled to the chassis 300 via the heat sink 210 (which is, in turn, substantially fixed to the frame 250 that forms the chassis 300), the battery module 100 effectively minimizes the amount of relative motion between the chassis 300 and each cell 270 during operation, reducing damaging forces to cells 270 (e.g. due to cell separation, etc.). Furthermore, the close proximity of each cell 270 to a thermal management component allows for increased thermal management of each cell 270. In a specific embodiment wherein the broad face of the cell 270 is coupled to the broad face of the heat sink 210, the large area of contact between the cell 270 and the heat sink 210 may facilitate even better cell thermal management. Second, the battery module configuration reduces the overall battery module volume by utilizing the thermal management components (e.g. the heat sink 210, manifold 230, etc.) as structural components, eliminating the need for a separate cell support structure. In a specific embodiment wherein the manifold 230 forms a frame component, more preferably a structural frame component (e.g. a frame edge), the battery module volume may be even further reduced. Third, by dividing the cells into an arrangement of substantially identical cartridges 200, the battery module 100 becomes modular, and allows for flexible power expansion and/or reduction though the addition or removal of cartridges 200.

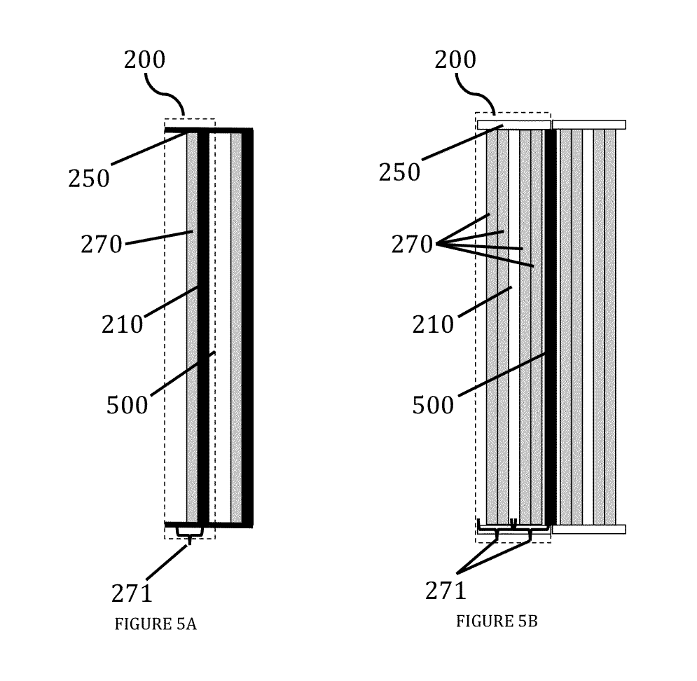

The cartridge 200 of the battery module 100 functions to cool and structurally support the batteries of the battery module 100, and may function to protect and compress the batteries as well. As previously described, the battery module 100 preferably includes multiple cartridges 200, but may alternatively include any suitable number of cartridges 200. The cartridges 200 of the battery module 100 are preferably substantially identical, but may alternatively be different (e.g. different thermal management components, cell types, number of batteries, etc.). The cartridges 200 are preferably coupled together in a stack along the thickness direction (normal to the plane of the batteries), but may be coupled together in any suitable configuration. As shown in FIG. 1B, the cartridge 200 preferably includes a heat sink 210, a manifold 230 fluidly coupled to the heat sink 210, a frame 250 supporting the heat sink 210, and a cell 270 coupled to the heat sink 210, as shown in FIG. 5A. More preferably, the cartridge 200 includes a heat sink 210 bounded by two manifolds 230 (an inlet and an outlet manifold 230), a frame 250 that supports the heat sink 210, and two cell stacks 271, wherein each stack is coupled to a face of the broad plate.

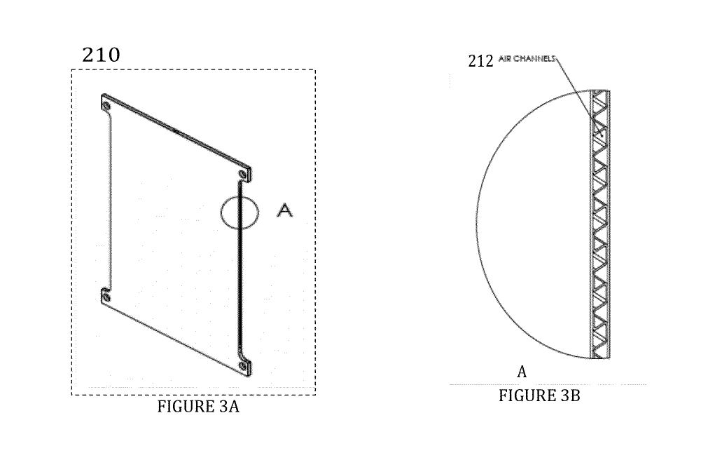

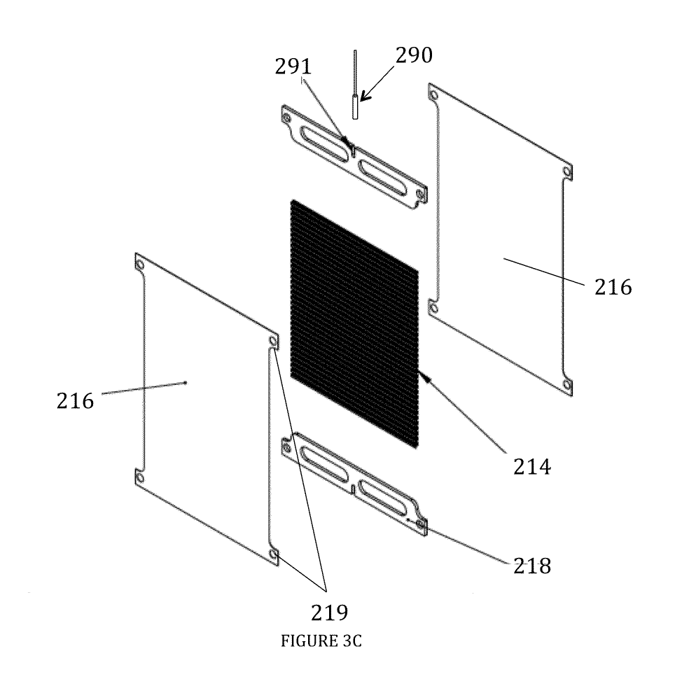

The heat sink 210 of the cartridge 200 functions to support, cool, and compress the coupled cell 270. As shown in FIG. 3A, the heat sink 210 is preferably rigid and preferably prismatic, more preferably rectangular prismatic and substantially flat, such that the heat sink 210 has a first and a second broad face. However, the heat sink 210 may be circular, hexagonal, convex, concave, or any other suitable shape. The broad face of the heat sink 210 is preferably slightly larger than the broad face of the cell 270, but may alternatively be larger (e.g. multiple cell widths and/or lengths) or smaller. The heat sink 210 is preferably made of a thermally conductive material such as metal (e.g. copper, aluminum, stainless steel, gold, or any suitable alloy), but may alternatively be made of a metal-coated polymeric material, a polymer, a combination of the above or any suitable heat sink material. As shown in FIG. 3B, the heat sink 210 preferably includes an internal thermal management channel 212 that accepts a thermal management fluid, but may alternatively be substantially solid. The internal thermal management channel 212 preferably includes an inlet and an outlet, wherein the inlet and outlet of the thermal management channel 212 preferably terminate on the edges of the heat sink 210. More preferably, the heat sink 210 includes a plurality of thermal management channels 212, wherein the ends of the thermal management channels 212 preferably terminate on opposing edges of the heat sink 210 (e.g. on the longitudinal edges of the heat sink) but may alternatively terminate on any edge of the heat sink 210. The thermal management channels 212 are preferably substantially straight and preferably extend in parallel through the width of the heat sink 210, but may alternatively extend in parallel along the length of the heat sink 210, curve through the interior of the heat sink 210 in a serpentine pattern, extend partially through the width and partially along the length of the heat sink 210, or trace any suitable pattern through the heat sink 210. The thermal management channels 212 preferably have a constant cross-section, but may alternatively have a variable cross-section. The thermal management channels 212 are preferably substantially identical, but may alternatively be different (e.g. different cross-sections, flow paths, etc.). As shown in FIG. 3C, the heat sink 210 is preferably formed from two substantially continuous plates 216 with a channel-forming element 214 interposed in between. As shown in FIG. 3B, the channel-forming element 214 is preferably a sheet of thermally conductive material, bent in a crenellated pattern, wherein the crenels form the thermal management channels 212 when the channel-forming element 214 is coupled to the plates 216. However, the heat sink 210 may be formed from a sheet, bent in a sawtooth pattern, interposed between two substantially flat, conductive plates; from a plurality of thermally conductive, hollow tubes joined together (e.g. along their longitudinal axes); from two parallel conductive plates joined together by a plurality of strips extending normal to the plates' broad faces; or from any other suitable construction. The heat sink 210 may additionally include retention beams 218 that function to retain the channel-forming element position within the heat sink 210. For example, the heat sink 210 may include a first and a second transverse beam that couple to the transverse ends of the heat sink 210, wherein the transverse beams are interposed between the plates of the heat sink 210 and provide a structural member for the heat sink 210 in the transverse direction as well as to seal the heat sink 210 and prevent thermal management fluid leakage into the module body. However, the heat sink 210 may include any suitable retention element. The heat sink 210 may additionally include alignment features 219 that function to align the heat sink 210 with the frame 250 and/or manifold 230. The alignment features 219 are preferably through-holes in the corners of the heat sink 210, wherein the holes extend through the thickness of the heat sink 210. However, the alignment features 219 may alternatively include grooves, clips, or any other suitable alignment feature 219.

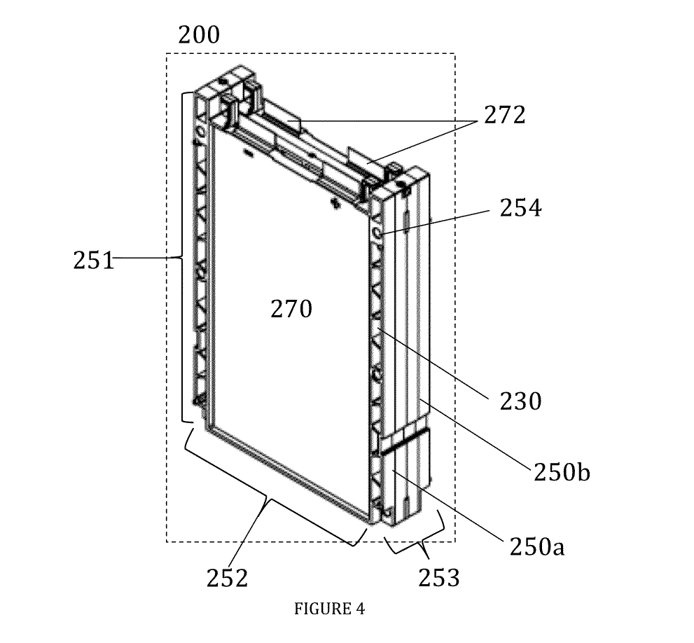

As shown in FIG. 1A, the manifold 230 of the cartridge 200 functions to facilitate thermal management fluid ingress and/or egress to and from the heat sink 210. More specifically, the manifold 230 functions to accept and/or provide thermal management fluid to one or more of the thermal management channels 212 of the heat sink 210. The manifold 230 preferably includes a channel end and a distal end, wherein the channel end is preferably fluidly coupled to the thermal management channel 212 of the heat sink 210, and the distal end is preferably fluidly coupled to a thermal management fluid reservoir. The manifold 230 preferably couples the thermal management channels 212 of the heat sink 210 together in parallel (e.g. the manifold 230 is simultaneously open to all the thermal management channels 212), but may alternatively provide thermal management fluid to the thermal management channels 212 in series. For example, the thermal management end of the manifold 230 preferably includes an open gap aligned with the end of the thermal management channel 212, but may alternatively include multiple ports along the length of the manifold 230, tubes that extend from the manifold 230, or any suitable fluid couple. The distal end of the manifold 230 is preferably normal to the channel end, such that the thermal management fluid traces an angled flow path through the manifold 230. The distal end is preferably located on the side of the manifold 230, such that the thermal management fluid flows substantially normal to the heat sink 210 through the distal end of the manifold 230 (wherein the manifold 230 is coupled along its length to the heat sink edge). However, the distal end may be located on an end of the manifold 230, or in any other suitable position. As shown in FIG. 4, the manifold 230 is preferably formed from a truss structure, more preferably a planar truss structure, wherein an open side of the truss structure forms the distal end, and the channel end is formed in a chord of the truss structure. Both sides of the truss structure are preferably open, such that thermal management fluid flow is allowed through the manifold 230 and into the manifold 230 of the adjacent cartridge 200, but one or both sides of the manifold 230 may be substantially sealed to affect the desired fluid flow path. However, the manifold 230 may alternatively be a substantially closed cylinder, wherein the channel ends are ports, aligned with the thermal management channels 212, in the cylinder wall, and wherein the distal end is the open end of the cylinder. Alternatively, the manifold 230 may have any suitable configuration and construction. When multiple cartridges 200 are coupled together in a stack, the manifolds 230 of the cartridge stack 130 are preferably fluidly coupled in series, but may alternatively be fluidly coupled in any suitable manner (e.g. in parallel or with a combination of parallel and series connections). The cartridge 200 preferably includes two manifolds 230, wherein the first manifold 230 is preferably fluidly coupled to the inlet(s) of the thermal management channel(s) 212, and the second manifold 230 is preferably fluidly coupled to the outlet(s) of the thermal management channel(s) 212. However, the cartridge 200 may include a single manifold 230 fluidly coupled to the thermal management channel 212 inlet; three manifolds 230, wherein two manifolds 230 are coupled to different thermal management channel 212 inlets and one manifold 230 is coupled to all the thermal management channel 212 outlets; or any suitable number of manifolds 230 in any suitable configuration. The first and second manifolds 230 are preferably coupled, more preferably joined, to the respective heat sink edge that the thermal management channel 212 inlet and outlet terminates on, but may alternatively be partially coupled to or not be coupled to the heat sink 210 at all. In one embodiment, the manifold 230 preferably forms an edge of the frame 250. In this embodiment, the manifold 230 functions as a component of the frame 250, supporting the heat sink 210 and protecting the coupled batteries. More preferably, in this embodiment, the first and second manifolds 230 form the opposing longitudinal edges of the frame 250. However, the manifolds 230 may form perpendicular edges of the frame 250 or the transverse edges of the frame 250. In a second embodiment, the manifold 230 is integrated into the heat sink 210, wherein the manifold 230 is a tube fluidly coupled to the thermal management channels 212 by ports in the wall of the tube. However, the manifold 230 may have any other suitable construction and placement. The manifold 230 is preferably made of an electrically and thermally insulative material, such as a polymer (e.g. PTFE, PEG, polyacrylamide, etc) or ceramic, but may alternatively be made of a thermally conductive material (e.g. a metal, such as copper, aluminum, or an alloy) that may or may not be electrically insulated. The manifold 230 is preferably injection molded, but may alternatively be sintered, cast, bent, or utilize any suitable manufacturing method.

As shown in FIG. 4, the frame 250 of the cartridge 200 functions to support the heat sink 210 and to mechanically protect a portion of the cell 270. More preferably, the frame 250 entirely encapsulates and protects the heat sink 210 and extends past the cell 270 such that the cell 270 is entirely encapsulated and protected by two adjoining frames 250 when the cartridge 200 is coupled to an adjacent cartridge 200. The frame 250 is preferably substantially statically coupled, more preferably joined, to the heat sink 210. The frame 250 preferably traces the perimeter of the heat sink 210, and is preferably rectangular, including a pair of opposing longitudinal edges 251 (running along the frame 250 length) and a pair of opposing transverse edges 252 (running along the frame 250 width). The frame 250 preferably has a thickness 253 slightly larger than or substantially equal to the total thickness of the heat sink 210 and the intended cell stack thickness. In other words, the distance the frame 250 extends from the heat sink 210 (normal to the broad face of the heat sink 210) is preferably enough to encapsulate/extend past the batteries coupled to the heat sink 210. For example, in the specific embodiment shown in FIG. 5B, the cartridge 200 includes four batteries, with the first and the second batteries joined along a broad face to the first and second broad face of the heat sink 210, respectively, and the third and fourth batteries joined along a broad face to the uncoupled broad faces of the first and second batteries, respectively. In this embodiment, the frame 250 preferably has a thickness greater than the heat sink-cell stack unit (e.g. has a thickness greater than the heat sink thickness and the cell stack thicknesses, combined). However, the frame 250 may have a thickness that is thinner than the heat sink-cell stack unit, or any other suitable thickness. As shown in FIG. 1B, the frame 250 is preferably formed from two halves 250a and 250b , wherein each half couples to the edges of a broad face of the heat sink 210 (e.g. the first and second broad face, respectively) such that the heat sink 210 is interposed between the two halves 250a and 250b. However, the frame 250 may be formed from two halves that bracket the heat sink edges, wherein the heat sink 210 is inserted into each half; may be formed from a single piece, wherein the heat sink 210 is slid 330 into the frame 250 from an edge; or may be formed from any suitable configuration and support the heat sink 210 in any suitable manner. The halves 250a and 250b are preferably substantially identical, such that the frame 250 is substantially symmetric about the join line, but may alternatively be different such that the frame is asymmetric about the join line. The frame edges preferably include truss-like structures, and more preferably are constructed from trusses (e.g. a Virendeel truss, Brown truss, Pratt truss, etc.) but may alternatively be constructed from I-beams, square beams, or any other suitable construction. The trusses of the frame edges are preferably oriented such that the open side of the truss is aligned parallel to the broad face of the heat sink 210 (e.g. such that a chord of the truss extends parallel to the heat sink edge), but may alternatively have any suitable orientation. Each pair of opposing frame edges is preferably substantially identical (e.g. the longitudinal edges preferably have the same construction and the transverse edges preferably have the same construction), but may alternatively have different construction. As aforementioned, the manifolds 230 preferably form the longitudinal edges of the frame 250, but may alternatively form any portion of the frame 250 or be unassociated with the frame altogether. In this embodiment, the channel end of each manifold 230 is preferably a gap that traces the heat sink edge, wherein the gap is formed between the two halves of the frame 250. The frame 250 is preferably made of a polymer, more preferably a thermoset, but may alternatively be made from any suitable polymer, ceramic, metal, or combination thereof.

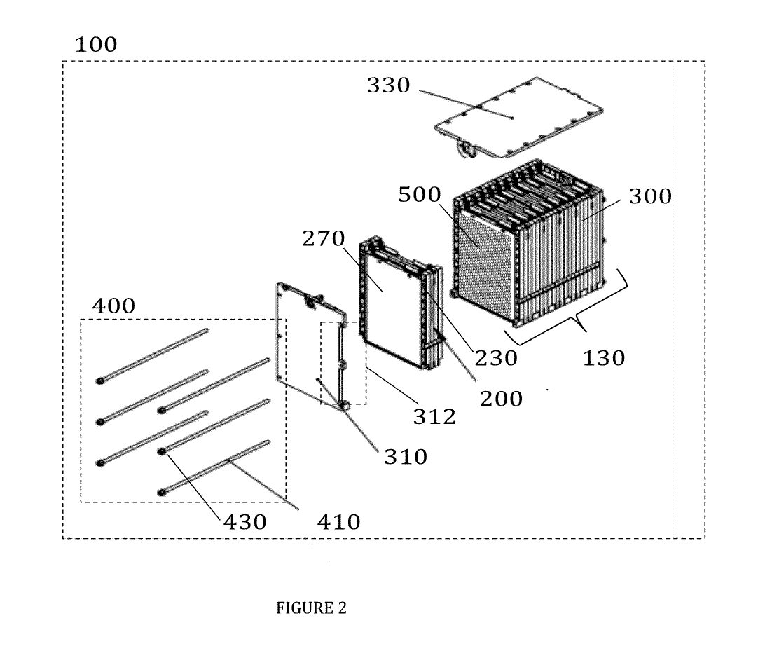

The frame 250 may additionally include locator features 254 that function to locate and/or orient the frame 250 and any auxiliary components. In one embodiment, the frame 250 includes a heat sink locator that functions to locate the heat sink 210 with respect to the frame 250 (e.g. orients the frame 250 to substantially frame 250 the heat sink 210). The heat sink locator preferably includes pegs that couple through complimentary holes in the heat sink 210, wherein the pegs and complimentary holes are preferably located in the corners of the frame 250 and heat sink 210, respectively. However, the heat sink locator may include through-holes in the frame 250 through which an alignment rod passes, grooves, clips, clamps, or any other suitable feature on the heat sink 210 or frame 250 that locates the heat sink 210 with respect to the frame 250. In a second embodiment, the frame 250 includes a frame alignment feature that functions to align the two halves of the frame 250. The frame alignment feature preferably includes a set of complimentary tabs and grooves disposed along the edges of the frame 250, more preferably along the frame 250 edges proximal to the heat sink 210. However, the frame alignment feature may alternatively include adhesive, clips, through-holes in the frame 250 through which an alignment rod passes, grooves, joints, or any other suitable feature that aligns and/or couples the frame halves 250a and 250b, and may be located on the frame halves or the heat sink 210. In a third embodiment, the frame 250 includes a cartridge alignment feature that functions to align adjacent cartridges 200. The cartridge alignment feature is preferably included on the frame 250, but may alternatively be included on the cell 270, the heat sink 210, the manifold 230, or an auxiliary component of the cartridge 200 or battery module 100. The cartridge alignment feature is preferably substantially similar to the frame alignment feature, allowing for each frame 250 half to be substantially identical, but may alternatively be different from the frame alignment feature. The cartridge alignment feature preferably includes a set of complimentary tabs and grooves, but may alternatively/additionally include through-holes in the frame 250 through which an alignment rod passes, drawer slide mechanisms, clips, or any other suitable cartridge alignment feature. In a fourth embodiment, the frame 250 includes a temperature sensor locator 291 that functions to locate and retain a temperature sensor 290. The temperature sensor locator is preferably a groove, such that the temperature sensor locator substantially encapsulates the temperature sensor 290, but may alternatively be a clip or any other suitable retention mechanism. The temperature sensor locator is preferably located on a transverse edge of the frame 25o, more preferably near the electrical connections 272 of the cell 270, but may alternatively be located in any suitable location. In a fifth embodiment, the frame 250 includes a wire guide that functions to guide and retain wires. The wire guide is preferably a hook, but may alternatively be a channel, a clip, a zip tie, or any suitable retention mechanism. The wire guide is preferably located on a transverse edge of the frame 250 and extends from the frame 250 in parallel with the longitudinal edges; more preferably, the wire guide is located near the electrical connections 272 of the cell 270. However, the wire guide may alternatively be located in any suitable position or orientation. The frame 250 may include any combination of the aforementioned locator features 254, or may include a single mechanism that functions as multiple features. In one embodiment, as shown in FIG. 2, the locator feature 254 includes six alignment rods 410, a though-hole in each of the four corners of the heat sink 210 and the frame 250, and two additional through holes through the centers of the longitudinal edges of the frame 250, wherein the central axis of the holes are normal to the broad face of the heat sink 210. The six alignment rods 410 pass through the six holes (one in each corner and one through each frame 250 longitudinal edge center) to align the frame halves 250a and 250b relative to the heat sink 210. The alignment rods 410 are preferably longer than the thickness of the frame 250, such that the rods may additionally align adjacent cartridges (which preferably include the same locator feature 254). In this embodiment, the one locator feature 254 functions as the heat sink locator, the frame alignment feature, and the cartridge alignment feature.

The battery cell 270 of the cartridge 200 functions to store and provide energy. As shown in FIGS. 1 and 4, the cell 270 is preferably prismatic, more preferably rectangular with a first and a second broad face. The cell 270 is preferably a rechargeable cell, and may be lithium polymer, lithium ion, nickel-cadmium, zinc bromide, or any other suitable rechargeable cell 270. The cell 270 preferably includes electrical connections 272 (e.g. a positive and negative terminal), wherein the electrical connections 272 are preferably located on a transverse edge of the cell 270. However, the electrical connections may be located on a longitudinal edge of the cell, on different cell edges (e.g. on opposing transverse or longitudinal edges, adjacent edges, etc.), or in any suitable configuration. The cell 270 is preferably electrically coupled in parallel with other batteries within the cartridge 200 and/or battery module 100, but may alternatively be coupled in series or in any suitable manner. The cell 270 is preferably electrically coupled to the other batteries by bus bars extending from the electrical connections 272, but may alternatively be coupled by wires, electrical spring connectors, fasteners, the frame 250, or by any suitable electrical connector. The cell 270 is preferably substantially statically coupled to the chassis 300 by coupling to the heat sink 210, wherein an entire broad face of the cell 270 is preferably coupled to an entire broad face of the heat sink 210. However, the cell 270 may alternatively couple to a portion of the heat sink broad face (particularly when the cell 270 is smaller than the heat sink 210 surface area). The cell 270 is preferably joined to the heat sink 210 by an adhesive, more preferably by a heat-conductive adhesive that preferably conforms to the face of the cell 270 (such as a pressure sensitive acrylic, nitrile, silicone, or polymer adhesive; any other suitable pressure sensitive adhesive; or any other suitable adhesive), but may alternatively be coupled by grooves, wherein the batteries slide into the grooves, by clips, tie-downs, or any suitable coupling and/or retention mechanism. Each cartridge 200 preferably includes multiple cells, wherein the cells are preferably substantially evenly distributed between the first and second broad faces of the heat sink 210. When more than two cells are included in the cartridge 200, the cells are preferably coupled together to form a cell stack 271, wherein an uncoupled broad face of the cell stack is preferably coupled to a broad face of the heat sink 210. The cell stack is preferably formed from multiple cells stacked along the cell thickness (i.e. coupled along a broad face to an adjacent cell). However, the cell stack may include multiple cells coupled along the cell edges (e.g. transverse and/or longitudinal edges) to form a substantially planar configuration (e.g. a planar cell stack one or more cell widths wide and/or one or more cell lengths long). Multiple planar cell stacks may be coupled along the broad faces to form a larger cell stack. The cells within each cell stack are preferably oriented in the same direction, such that the positive (or negative) terminals of the cells in the stack are aligned. However, the cells 270 may be arranged such that the cell terminals are misaligned, or may be arranged in any suitable configuration. Each cartridge 200 within the battery module 100 preferably includes the same number of cells 270, but the cartridges 200 may alternatively include different numbers of cells. In the specific embodiment shown in FIG. 5B, each cartridge 200 in the battery module includes four cells, with the first and second cell 270 directly joined along their broad faces to the first and second broad faces of the heat sink 210, respectively, and the third and fourth cells joined along their broad faces to the uncoupled broad faces of the first and second cells, respectively. In a second specific embodiment, each cartridge 200 includes eight cells 270 coupled to a heat sink 210, wherein the heat sink 210 width is approximately two cell widths. In this embodiment, the cells 270 are divided into four cell pairs, wherein the cells in each pair are coupled to the other along a longitudinal edge. The first and second cell pairs are directly joined along a broad face to the first broad face of the heat sink 210, and the third and fourth cell pairs are directly joined along a broad face to the uncoupled broad faces of the first and second cell pairs, respectively. However, one skilled in the art may envision other cartridge 200 and cell 270 configurations. The cell stack thickness per heat sink face is preferably a maximum of two cells thick (e.g. each cartridge 200 is preferably four cells thick) to achieve adequate thermal management and module energy density; however, each cell stack (and subsequently, cartridge 200) may be any suitable thickness and include any suitable number of cells

The cartridge 200 may additionally include a temperature sensor 290 that functions to measure the temperature of the cartridge 200, wherein the cartridge temperature measurement may be used to adjust the battery module 100 operational parameters. In one embodiment, the thermal management fluid flow is preferably increased when the cartridge temperature surpasses a predetermined temperature threshold, and decreased when the cartridge temperature falls below a second predetermined temperature threshold. In a second embodiment, the maximum allowable load (and subsequently, the applied load) on the cell 270 is decreased when the cartridge temperature passes a predetermined temperature threshold, and increased when the cartridge temperature falls into the operational range. The temperature sensor 290 is preferably placed near the electrical connections 272 of the cells, but may alternatively be located anywhere within the cartridge 200. As shown in FIG. 3C, the temperature sensor 290 is preferably located within the heat sink 210, and is preferably held by a groove in the transverse retention beam 218 of the heat sink 210. However, the temperature sensor 290 may be located in the frame 250, on a cell 270, or elsewhere within the heat sink 210. The temperature sensor 290 is preferably a thermistor, but may alternately be a thermometer (e.g. bi-metallic thermometer, resistance thermometer, etc), a thermocouple, thermal switch, or any other suitable temperature sensor. Each cartridge 200 preferably includes one temperature sensor, but may alternatively include multiple sensors (e.g. two, three, etc.) or no sensors. In the latter case, other cartridges 200 within the battery module (e.g. adjacent cartridges) preferably include one or more temperature sensors.

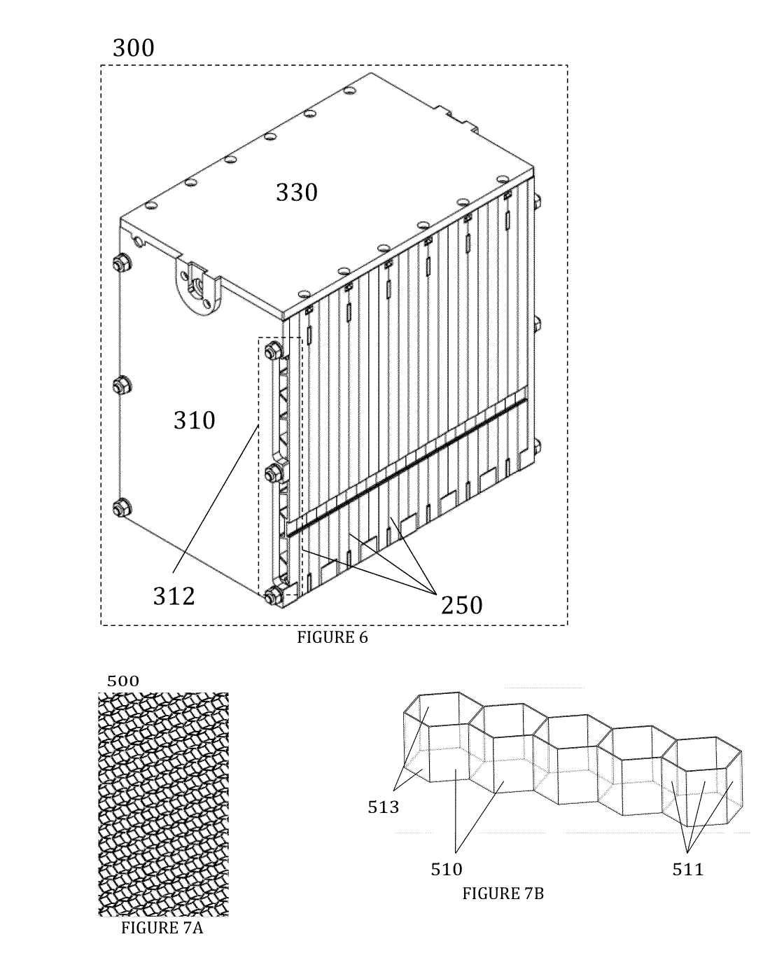

The chassis 300 of the battery module 100 functions to mechanically protect the batteries encapsulated therein. The chassis 300 is preferably formed from an end plate 310 and the frame 250 of the cartridge 200. More preferably, as shown in FIG. 6, the chassis 300 is formed from the coupled frames 250 of the battery module cartridges 200 and two end plates 310, wherein the two end plates 310 cap the uncoupled ends of the first and last cartridge 200 in the cartridge stack 130. The frames 250 are preferably stacked along the frame thickness to form the chassis 300 (e.g. the broad faces of the cartridges 200 are coupled together). However, the frames may be coupled along the longitudinal edges (e.g. along the manifolds 230) and/or along the transverse edges to form a planar battery module 100. The frames 250 may alternatively be coupled in any other suitable configuration. The end plates 310 are preferably substantially thin plates with a surface area substantially equivalent to the area of a broad face of the cartridge 200, but may alternatively be larger (e.g. multiple cartridge lengths long and/or wide) or smaller. Furthermore, each end plate 310 preferably includes a flow channel 312 that forms an inlet and/or outlet that allows thermal management fluid ingress and/or egress from the battery module 100. The flow channel 312 preferably includes a cut-out along the longitudinal edges of the end plates 310 (such that the end plates 310 form an “I” shape), wherein the cut-out preferably allows substantially direct access to a manifold 230 of the end cartridge of the cartridge stack 130, but may alternatively include holes along the longitudinal edges, micro-channels within the end plate 310, or any suitable flow channel 312. The end plates 310 may alternatively be substantially similar to the heat sinks 210 of the cartridge 200. The end plates 310 are preferably coupled to the cartridge frames 250 by a rod mechanism, wherein the alignment rod 410 of the cartridge frame 250 preferably extends through the end plates 310 as well. However, the end plates 310 may be coupled to the cartridge frames 250 by screws, clips, adhesive, clamps, or any other suitable coupling mechanism. The chassis 300 may additionally include a lid 330 that protects the electrical connections 272 of the cells, wherein the lid 330 couples to the end plates 310 to cover a transverse edge of the cartridge 200. The lid 330 is preferably coupled to the end plates 310 by a lip that overhangs the end plates 310, wherein a screw preferably joins the tab to the end plate 310. However, the lid 330 may be adhered, clipped, screwed, clamped, or otherwise coupled to the end plates 310 and/or cartridge frame(s) 250. The end plates 310 and lid 330 are preferably substantially rigid, and are preferably made of a polymeric material, but may alternatively be made of ceramic, metal, or a combination thereof.

As shown in FIG. 2, the battery module 100 may additionally include a compression member 400, wherein the compression member 400 functions to apply a substantially equal compressive force over the broad faces of the cells. More preferably, the compression member 400 compresses the cartridges 200 of the battery module 100 together to compress the cells 270 of the cartridges 200. Compression of the cells 270 has the benefit of reducing relative motion between the cells 270 and/or heat sinks 210, leading to potentially longer cell lifespans. The compression member 400 preferably compresses the end plates of the chassis 310 toward the interior of the battery module 100, such that the end plates 310 apply a substantially equal force over the broad faces of the cells. However, the compression member 400 may apply a force to the cells by coupling to the face of each cell 270 individually, by compressing the broad face of a first cartridge 200 toward the broad face of a second cartridge 200 (e.g. wherein a spring is disposed along the opposing broad face of the first cartridge 200), or by any other suitable means. The compression member 400 preferably includes an alignment rod 410 with tightening mechanisms 430 (e.g. a nut and bolt system, a stretched spring running through the length of the rod, etc), wherein the alignment rod 410 extends along the length of the battery module 100, preferably through the end plates 310 and the frames 250 of the composite cartridges 200, wherein the tightening mechanism 430 is preferably tightened against the end plates 310 to compress the battery module 100. More preferably, the compression member 400 includes several alignment rods 410 distributed substantially equally about the chassis 300, such that the compression member 400 applies a substantially equal force to the faces of the cells contained within the battery module 100. In this embodiment, the compression member 400 may additionally function to provide structural stability to the battery module 100 (e.g. reduce battery module torque, etc.). The compression member 400 may additionally function as a mounting mechanism to an external environment (e.g. a vehicle). In one variation, a first end of mounting feet/clips couple to the rods 410, preferably along the rod length but alternatively to the rod ends, wherein a second end of the mounting feet/clips couple to a vehicle or battery pack structure. Other mounting structures and/or methods may be envisioned within the scope of this invention. However, the compression member 400 may include spring force members (e.g. dampers, springs), disposed on the interior of the battery module 100 between an end plate 310 and an end of the cartridge stack 130; clamps that couple to the broad face of each end plate 310; or any other suitable mechanism that applies a substantially equal force over the faces of the cells within the battery module 100.

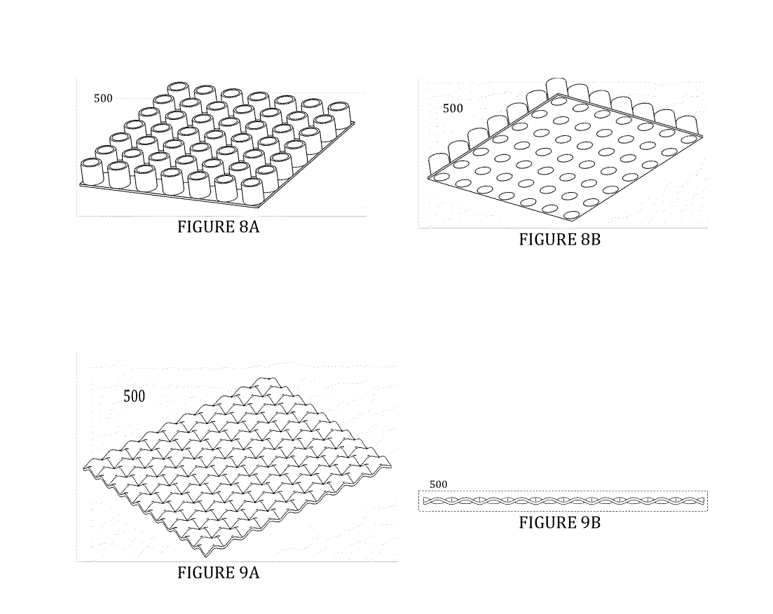

As shown in FIG. 2, the battery module 100 may additionally include a pressure member 500 that functions to facilitate even force distribution over the broad faces of each cell 270. The battery module 100 preferably includes a plurality of pressure members 500 interposed between each cartridge 200, such that each pressure member 500 couples to the broad faces of the adjacent batteries. However, the battery module 100 may include any suitable number of pressure members 500 in any suitable configuration. The pressure members 500 are preferably coupled to the cells 270 by a compressive force (preferably applied by the compression member 400), wherein the pressure members 500 are compressed during assembly, but may be adhered, clipped, or otherwise coupled to the adjacent cells. The pressure member 500 preferably provides a substantially constant force to the cell face over the pressure member compression regime (e.g. the pressure member 500 applies the same force to the cell face whether it is 10% compressed or 40% compressed), but may alternatively apply a range of forces to the cell face over the compression regime. The pressure member 500 is preferably substantially thin to minimize the battery module 100 volume, and preferably has a surface area substantially similar to the area of the cell face. As shown in FIG. 7A, in one embodiment, the pressure member 500 is preferably a sheet constructed from tessellated prisms 510, wherein the coupled prism bases 513 form the walls of the sheet. The walls of the prisms 511 are preferably constructed from thin strips, wherein the bases of the prisms are preferably formed from substantially continuous sheets. As shown in FIG. 7B, the prisms are preferably hexagonal prisms, but may alternatively be rectangular prisms, triangular prisms, circular prisms (as shown in FIGS. 8A and 8B), or any suitable shape. In a second embodiment, as shown in FIG. 9A, the pressure member 500 is preferably a sheet of tessellated protrusions of alternating camber, such that the side profile of the protrusions may trace a sinusoidal curve (as shown in FIG. 9B). The pressure member 500 may alternatively be a damper, a substantially continuous sheet of viscoelastic material (e.g urethane foam rubber, neoprene, polyethylene, polyurethane, silicone, etc.), foam, or any other suitable pressure member 500.

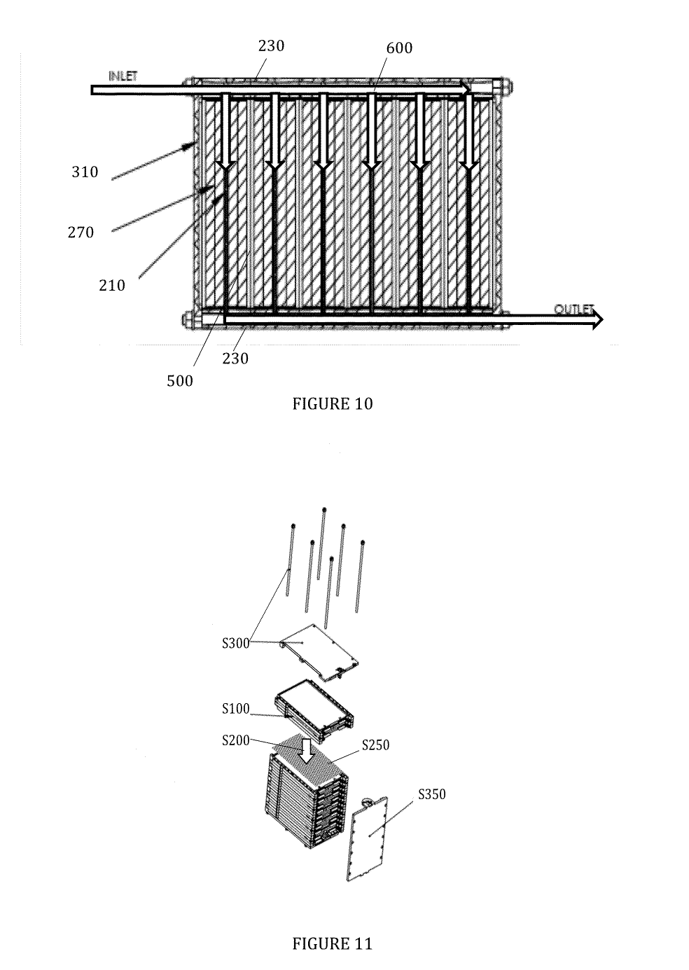

The battery module 100 preferably facilitates thermal management fluid flow through the manifolds 230 and heat sinks 210. As shown in FIG. 10, thermal management fluid preferably flows into each cartridge 200 in a direction normal to the broad face of the heat sink 210 (through the manifold 230), through the thermal management channels 212 of the heat sink 210, and out of the cartridge 200 in a direction normal to the broad face of the heat sink 210 (preferably through a second manifold 230). The manifolds 230 of the cartridges 200 are preferably coupled together in series, such that when the thermal management fluid enters one manifold 230, the thermal management fluid may flow into the adjacent cartridge 200 manifold 230 or may flow into the thermal management channels 212 of the heat sink 210. However, the manifolds 230 may be coupled together in parallel, or in any suitable coupling pattern. The thermal management fluid preferably enters the battery module 100 from a first longitudinal edge of the battery module loo; flows, in series, through the manifolds 230 aligned along the first longitudinal edge and in parallel through the heat sinks 210 coupled to the manifolds 230; and exits the battery module 100 from a second longitudinal edge that is oblique to the first. However, the thermal management fluid may enter the battery module 100, flow in series through the manifolds 230 and in parallel through the heat sinks 210, and exit the battery module 100 from a longitudinal edge adjacent to the first (e.g. wherein the manifolds' distal ends are blocked by a portion of the end plate 310 or by any other suitable blocking means). The thermal management fluid may also traverse through the thermal management plates in series, tracing a sinusoidal path through the battery module 100 (e.g. wherein the distal ends/sides of alternating manifolds 230 are blocked), or may have any other suitable flow path 600.

As shown in FIG. 11, the battery module is preferably assembled by assembling individual cartridges S100, stacking the cartridges along the thickness direction S200, and coupling the cartridges together with an end plate and a compression member S300. The step of assembling a cartridge S100 includes the steps of assembling the heat sink, aligning the manifold with the heat sink, and coupling the cell to the heat sink. The heat sink is preferably pre-assembled, but assembling the heat sink may include coupling the channel-forming element to the plates of the heat sink. The step of aligning the manifold to the heat sink preferably includes aligning the frame with the edges of the heat sink (e.g. with an alignment rod), but may alternatively include sliding the heat sink into a groove in the manifold/frame, clipping the heat sink to the manifold/frame, or any other suitable method of aligning the manifold with the heat sink. The step of coupling the cell to the heat sink preferably includes aligning the cell with the heat sink and adhering the cell to the heat sink, but may alternatively include clipping the cell to the heat sink, sliding the cell into a groove on the heat sink, or any other suitable method of coupling the cell to the heat sink. The complete cartridges are preferably stacked in a top-down manner, wherein the next cartridge is preferably placed broad-side down on the cartridge stack. In one specific embodiment, the stacking step functions to align the cartridges and potentially the end plate. In this embodiment, the alignment rods are preferably fixed such that the rods extend upwards, wherein the locator features of end plate and cartridges (e.g. holes) are aligned with the rods and slipped over the rods. In this embodiment, each cartridge may not be fully assembled (e.g. the frame may not be joined to the heat sink), wherein the stacking process aligns, couples, and forms a complete cartridge. The stacking step may additionally include inserting a pressure member between each cartridge S250, wherein the pressure members are preferably introduced during the stacking step of the assembly process (e.g. the stacking step includes alternating steps of stacking a cartridge and stacking a pressure member onto the cartridge stack). The coupling step S300 preferably couples and compresses all the components within the battery module, and may additionally function to align all the components. The coupling step preferably includes stacking an end plate to the completed cartridge stack, and tightening the compression member against the end plate to compress the battery module. In a specific embodiment, nuts are preferably tightened along the alignment rod against the end plate to compress and couple the components of the battery module together. The assembly method may additionally include the step of coupling a lid to the cartridge stack S350, wherein this step preferably occurs after the end plates have been coupled to the cartridge stack.

As a person skilled in the art will recognize from the previous detailed description and from the figures and claims, modifications and changes can be made to the preferred embodiments of the invention without departing from the scope of this invention defined in the following claims.

We claim:

1. A battery module comprising:
a plurality of substantially identical cartridges, each cartridge including:
a heat sink including a thermal management channel and having a first broad face and a second broad face;
a prismatic battery cell coupled along a broad face to the first broad face of the heat sink;
a first and a second manifold, fluidly coupled to the thermal management channel, that form opposing edges of a frame, wherein the frame supports the edges of the heat sink;
wherein the plurality of cartridges are coupled together in a direction normal to the broad face of the heat sinks to form a stack with a first and a second end;
a chassis formed from a first end plate, a second end plate, and the plurality of frames, wherein the first and second end plates cap the first and second ends of the stack, respectively; and
a compression member that applies a compressive force over the prismatic battery cell.

2. The battery module of claim 1, wherein the frame is formed by a first and a second half, wherein the heat sink is interposed between the first and second halves.

3. The battery module of claim 1, wherein each cartridge further includes a pressure member interposed between adjacent cartridges in the stack, wherein the pressure member applies a substantially equal force over the broad faces of the adjacent batteries.

4. The battery module of claim 1, wherein each cartridge further includes a second, third, and fourth battery cell that are substantially similar to the first, wherein the second cell is coupled along a broad face to the uncoupled broad face of the first cell, the third cell is coupled along a broad face to a second broad face of the heat sink, and the fourth cell is coupled along a broad face to the uncoupled broad face of the third cell.

5. A battery module comprising:
a cartridge including:
a prismatic heat sink with a first and second broad face, the heat sink including a thermal management channel there through with an inlet and an outlet, wherein the inlet and outlet terminate at a first and second edge of the heat sink, respectively;
a manifold with a fluid inlet that is fluidly coupled to the inlet of the thermal management channel;
a prismatic battery cell joined along a broad face to the first broad face of the heat sink;
wherein the cartridge facilitates flow of a thermal management fluid therethrough;
a prismatic end plate;
a compression member that compresses the end plate toward the cell.

6. The battery module of claim 5, wherein the battery module includes a second cartridge, substantially identical to the first, interposed between the first cartridge and the end plate, such that the compression member compresses the second cartridge between the first cartridge and the end plate.

7. The battery module of claim 6, wherein the battery module further includes a pressure member disposed between the first and second cartridges.

8. The battery module of claim 7, wherein the pressure member applies a substantially constant force over the face of the cell.

9. The battery module of claim 8, wherein the pressure member is a substantially hollow sheet of tessellated hexagonal prisms formed from thin wall sheets, wherein the bases of adjacent hexagonal prisms form the walls of the pressure member.

10. The battery module of claim 5, wherein the cartridge further includes a second, third, and fourth prismatic cell, wherein the second prismatic cell is joined along a broad face to the second broad face of the heat sink, and the third and fourth cell are joined along a broad face to the uncoupled broad face of the first and second cell, respectively.

11. The battery module of claim 10, wherein the first and third batteries are electrically coupled together in parallel.

12. The battery module of claim 5, wherein the heat sink is a rectangular plate.

13. The battery module of claim 12, wherein the heat sink includes a first and a second plate that enclose the thermal management channel, wherein the first and second plates form the first and second broad faces of the heat sink, respectively.

14. The battery module of claim 12, wherein the heat sink includes a thermistor, wherein the cell includes electrical tabs, and wherein the thermistor is located proximal to the electrical tabs.

15. The battery module of claim 12, wherein the heat sink includes a plurality of thermal management channels extending in parallel therethrough.

16. The battery module of claim 15, wherein the thermal management channels extend along the width of the heat sink.

17. The battery module of claim 16, wherein the thermal management channels are formed from a sheet of conductive material bent in a crenellated pattern, wherein the crenels form the thermal management channels.

18. The battery module of claim 5, wherein the cartridge further includes a second manifold, fluidly coupled to the thermal management channel outlet, wherein the first and second manifolds are disposed along opposing edges of the heat sink.

19. The battery module of claim 18, wherein the first and second manifold form the longitudinal edges of a frame.

20. The battery module of claim 19, wherein the frame is formed from a first and a second half that join to the edges of the first and second broad faces of the heat sink, respectively, such that the heat sink is interposed between the first and second frame halves.

21. The battery module of claim 20, wherein the first and second manifolds are fluidly coupled to the inlet and outlet of the thermal management channel, respectively, by a first and second gap formed along the first and second edge of the heat sink, respectively, by the joined frame halves.

22. The battery module of claim 5, wherein the battery module includes an alignment feature that aligns the end plate and the cartridge.

23. The battery module of claim 22, wherein the alignment feature includes a bore, normal to the broad faces of the end plate and cartridge, that runs through the edge of the end plate and the edge of the cartridge, wherein the compression member is a tension rod that extends through the bore.

24. The battery module of claim 5, wherein the first manifold includes a fluid inlet that accepts a thermal management fluid, wherein the fluid inlet is substantially perpendicular to the thermal management channel inlet.

25. The battery module of claim 24, wherein the first manifold include a truss structure, wherein an open side of the truss structure forms the fluid inlet.

26. The battery module of claim 5, wherein the thermal management fluid is air.

27. The battery module of claim 5, wherein the thermal management fluid exits the cartridge from an edge oblique to the fluid inlet.

28. A cartridge for use in a battery module, the cartridge comprising:
a rectangular prismatic heat sink with a first and a second broad face, the heat sink including:
a first and second plate that form the first and second broad face of the heat sink, respectively;
a plurality of thermal management channels extending through the heat sink, transverse to the heat sink thickness, wherein the thermal management channels initiate and terminate on the edges of the heat sink; and
a frame, including a first and a second half that couple to the edges of the first and second broad face of the heat sink, respectively, wherein the first and second half cooperatively form a first and a second manifold on the longitudinal edges of the frame, wherein the first and second manifold are fluidly coupled to the thermal management channels.

29. The battery module of claim 28, wherein the cartridge further includes a first and a second prismatic cell joined to the first and second plates of the heat sink.

30. The battery module of claim 29, wherein the batteries are joined to the heat sink with adhesive.

31. The battery module of claim 28, wherein the thermal management channels are formed from a conductive sheet bent into a crenellated structure, wherein the sheet and plates of the heat sink cooperate to form thermal management channels in the crenels of the conductive sheet.

32. The battery module of claim 28, wherein the first and second manifold are formed from truss structures, wherein an open side of the truss structure forms a thermal management fluid inlet.
